(19) United States
(12) Patent Application Publication
(10) Pub. No.: US 2004/0196337 A1
(43) Pub. Date: Oct. 7, 2004

(54) Ink feeding member

(76) Inventors: Kazuhiro Yamamoto, Kurume-shi (JP); Hideya Kinoshita, Yokohama-shi (JP); Noriyuki Yamaguchi, Yokohama-shi (JP)

Correspondence Address: Sughrue Mion Zinn Macpeak & Seas, 2100 Pennsylvania Avenue N W, Washington, DC, 20037-3213, US

(21) Appl. No.: 10/491,628

(22) PCT Filed: Oct. 8, 2002
(86) PCT No.: PCT/JP02/10441

(30) Foreign Application Priority Data
Oct. 9, 2001 (JP) 2001-311318

(51) Int. Cl. B41J 2/175

(52) U.S. Cl. 347/85

(57) ABSTRACT

An ink feeding member comprising an ink tank for storing an ink, and an ink discharge control material placed in the ink tank to close an ink discharge port of the ink tank and to partially fill the ink tank, characterized in that the ink discharge control material is comprised of an ultra fine cell foam or a hot press formed product thereof with a density of 0.06 g/cm³ or more, quantity of cells of 100/in or more, and a ventilation volume of 0.002 to 40 cc/cm²/ sec.

### TECHNICAL FIELD

The present invention relates to an ink feeding member which is used, particularly, for feeding an ink to a printing head.

### BACKGROUND ART

In recent years, there has been a remarkable progress in OA apparatuses, and, with respect to printers, there has been occurring a shift from the wire dot system and thermal transfer system to the ink jet system.

In the ink jet system, it is a common practice to contain an ink holding member in an ink tank (ink containing vessel) in order to hold an ink uniformly in the tank.

As the ink holding member, a polyurethane foam or a hot press formed product thereof is used. Conventionally, it has been practiced to pack the ink holding member densely into the tank and hold the ink in the cells of the ink holding member (a polyurethane foam or a hot press formed product thereof).

Hitherto, however, the urethane foam comparable in size to the ink tank (ink cartridge) has thus been used and, therefore, it has been difficult to increase the amount of ink contained in the tank and to reduce the amount of ink remaining in the tank after use.

Besides, the build-up of a negative pressure has been slow, and it has taken time until the jetting of the ink is stabilized.

### DISCLOSURE OF INVENTION

Accordingly, it is an object of the present invention to provide an ink feeding member which makes it possible to increase the amount of ink contained and lower the ink remaining factor, to increase the use efficiency of ink, to obtain a sharp build-up of a negative pressure and shorten the time until stable jetting of ink, and to jet the ink stably.

In order to attain the above object, according to the present invention, there is provided an ink feeding member comprising an ink tank for containing an ink, and an ink discharge control material placed in the ink tank to close an ink discharge port of the ink tank and to partially fill the ink tank, characterized in that the ink discharge control material is composed of an ultra fine cell foam or a hot press formed product thereof with a density of 0.06 g/cm³ or more, quantity of cells of 100/in or more, and a ventilation volume of 0.002 to 40 cc/cm²/sec.

The ink feeding member according to the present invention comprises the ink discharge control material formed of the ultra fine cell foam or a hot press formed product thereof, which is placed in the ink tank (ink cartridge) to close an ink discharge port of the ink tank and to partially fill the ink tank (ink cartridge). This ensures that, while utilizing the characteristic that a negative pressure is built up even where the ink fills a portion on the upper side of the ink discharge control material, the use of the control material at a portion of the interior of the ink cartridge makes it possible to increase the amount of ink contained and lower the ink remaining factor, and to enhance the use efficiency of ink.

In addition, since the build-up of the negative pressure is sharp and the stability of the negative pressure is high, it is possible to shorten the time necessary for stabilization of jetting of ink and to achieve stable jetting of ink. Therefore, the ink feeding member according to the present invention can be used preferably as an ink feeding member for use in an ink jet type printer.

### BRIEF DESCRIPTION OF DRAWINGS

FIG. 1 is a perspective view of an ink cartridge used in Example and Comparative Example.

FIG. 2 is a graph showing negative-pressure characteristics in the case where a hot pressed product of fine cell foam with a pressing factor of 2 and the pressing direction being vertical was used.

FIG. 3 is a graph showing negative-pressure characteristics in the case where a hot pressed product of fine cell foam with a pressing factor of 2 and the pressing direction being lateral was used.

FIG. 4 is a graph showing negative-pressure characteristics in the case where a hot pressed product of fine cell foam with a pressing factor of 2.5 and the pressing direction being lateral was used.

FIG. 5 is a graph showing negative-pressure characteristics in the case where a hot pressed product of fine cell foam with a pressing factor of 3 and the pressing direction being vertical was used.

FIG. 6 is a graph showing negative-pressure characteristics in the case where a hot pressed product of fine cell foam with a pressing factor of 3 and the pressing direction being lateral was used.

FIG. 7 is a graph showing negative-pressure characteristics in the case where a hot pressed product of fine cell foam with a pressing factor of 3.5 and the pressing direction being lateral was used.

### BEST MODE FOR CARRYING OUT THE INVENTION

The ink feeding member according to the present invention comprises an ink tank and an ink discharge control material. In this case, as the ink tank, there can be used an ink cartridge used for an ink jet type printer, or the like.

On the other hand, as the ink discharge control material, there is used an ultra fine cell foam or a hot press formed product thereof with a density of 0.06 g/cm³ or more, particularly 0.065 g/cm³ or more, preferably 0.15 g/cm³ or less, more preferably 0.12 g/cm³ or less, quantity of cells of 100/in or more, particularly 120/in or more, preferably 200/in or less, and a ventilation volume of 0.002 cc/cm²/sec or more, particularly 10 cc/cm²/sec or more and 40 cc/cm²/sec or less, particularly 37 cc/cm²/sec or less.

If the density is too low, the foam has the problem that the negative pressure would not be built up. In this case, if the density is too high, the negative pressure is built up excessively, possibly making it difficult to press the foam. In addition, if the quantity of cells is too small, the negative pressure would not be built up. On the contrary, if the quantity of cells is too large, the negative pressure may be built up excessively. If the ventilation volume is too small, the ink would not be jetted uniformly. On the contrary, if the ventilation volume is too large, the negative pressure would not rise. Incidentally, the ventilation volume is a value measured according to JIS K 6400.

In this case, as the ink discharge control material, a hot press formed product of the above-mentioned foam is preferably used. The press direction in pressing the foam may be the vertical direction (ink flow-out direction) or the side direction (the direction perpendicular to the ink flow-out direction), or may be both of these directions. Where the pressing direction is the vertical direction, the pressing factor is preferably 2 to 3, more preferably 2 to 2.5. Where the pressing direction is the lateral direction, the pressing factor is preferably 2 to 4, more preferably 2.5 to 3.5. Incidentally, the hot pressing can be carried out by the normal method.

Here, as the foam, a soft polyurethane foam is preferably used, and a soft polyurethane foam free of cell films is more preferably used.

The ultra fine cell foam can be produced by any of known methods by which such an ultra fine cells can be obtained.

In the ink feeding member according to the present invention, the above-mentioned ink discharge control material is placed in the ink tank to close an ink discharge port of the tank and to partially fill the tank. In this case, the filling factor of the ink discharge control material in filling the ink tank is preferably 10 to 15%, more preferably 11 to 12%, based on the internal volume of the ink tank.

### EXAMPLE

The present invention will be described in detail by showing Example and Comparative Example, it being to be understood that the present invention is not limited to the following Example.

### Example and Comparative Example

Polyether-based polyurethane foams having densities, quantities of cells, and ventilation volumes as shown in Table 1 were prepared.

TABLE 1

| | | Ventilation | Quantity |
|---|---|---|---|
| | Density | volume | of cells |
| Material | (g/cm³) | (cc/cm²/sec) | (pieces/inch) |
| Comparative Example foam | 0.056 | 80.0 | 60 |
| Ultra fine cell foam 1 | 0.091 | 35.0 | 120 |
| Ultra fine cell foam 2 | 0.106 | 10.2 | 150 |
| Ultra fine cell foam 3 | 0.106 | 20.2 | 170 |
| Ultra fine cell foam 4 | 0.117 | 13.0 | 180 |

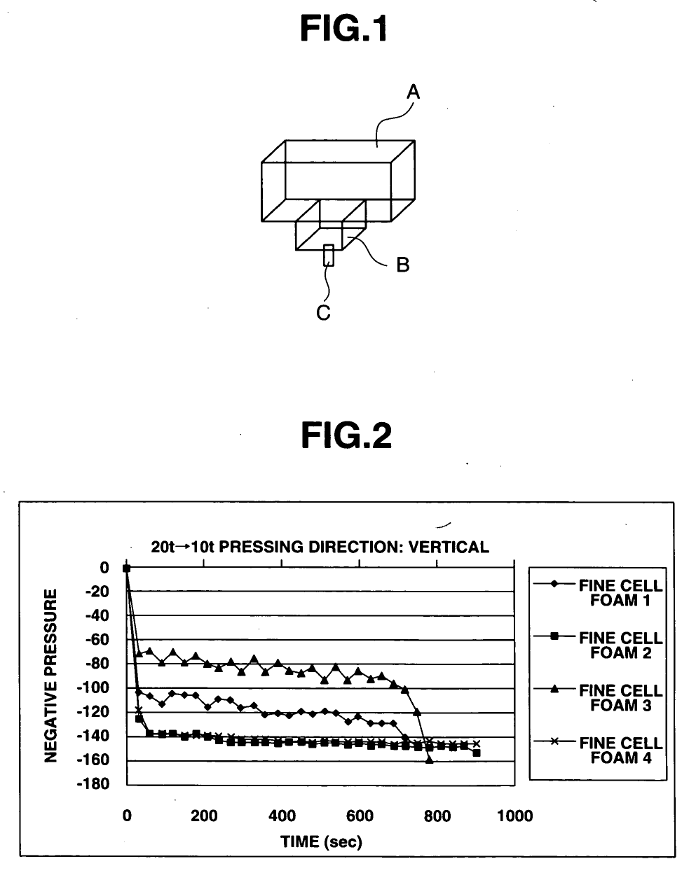

Next, each of hot pressed foams measuring 10 t×15×23 mm as shown in Table 2 was placed to fill a bottom portion (case lower portion B) of a case (case upper portion A: 23 t×50×23 mm; case lower portion B: 10 t×15×23 mm) shown in FIG. 1. In the figure, C denotes the ink discharge port. In the case of Comparative Example foam, the foam is placed to fill up the whole part of the case (namely, the case A and the case B). The filling with the foam was conducted as follows. First, the foam was immersed in 10% ethanol solution, the foam was pressed flat to remove air therefrom, and the 10% ethanol solution was poured into the case to fill up the case. Thereafter, the 10% ethanol solution was drawn off at a rate of 2.0 cc/min, and the negative pressure was measured at intervals of 30 sec. The results are shown in Table 2.

TABLE 2

| | | | | Stabi- | |
|---|---|---|---|---|---|
| | | | | lization | |
| | | | | time of | |
| | | | Ink | negative | Negative |
| | Pressing | Pressing | capacity | pressure | pressure |
| Material | factor | direction | (cc) | (sec) | (mmH₂O) |
| Comparative | — | — | 24.0 | 150 | −30 to −50 |
| Example foam | | | | | |
| Ultra fine | 2.5 | lateral | 26.5 | 30 | −40 to −60 |
| cell foam 1 | | | | | |
| Ultra fine | 3.5 | lateral | 26.5 | 30 | −50 to −60 |
| cell foam 2 | | | | | |
| Ultra fine | 2.0 | vertical | 26.5 | 30 | −60 to −80 |
| cell foam 3 | | | | | |
| Ultra fine | 2.5 | lateral | 26.5 | 30 | −100 to −110 |
| cell foam 4 | | | | | |

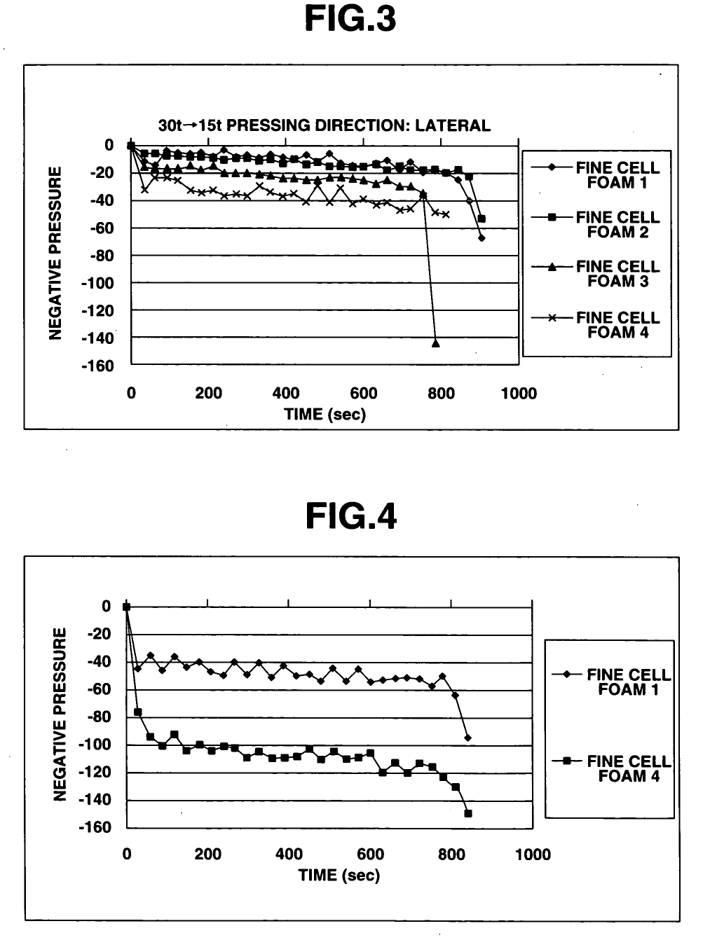

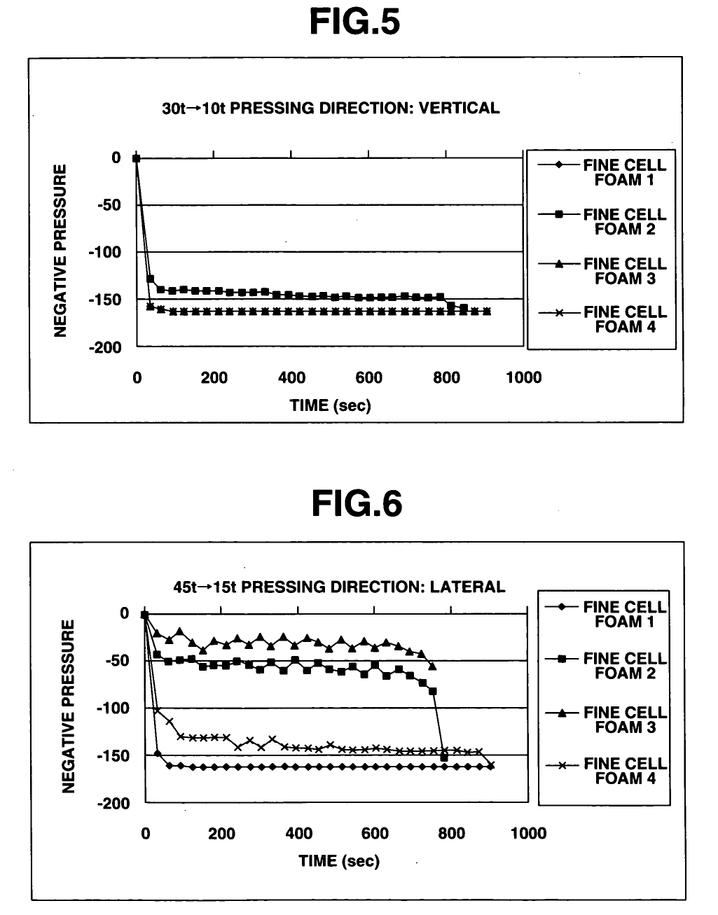

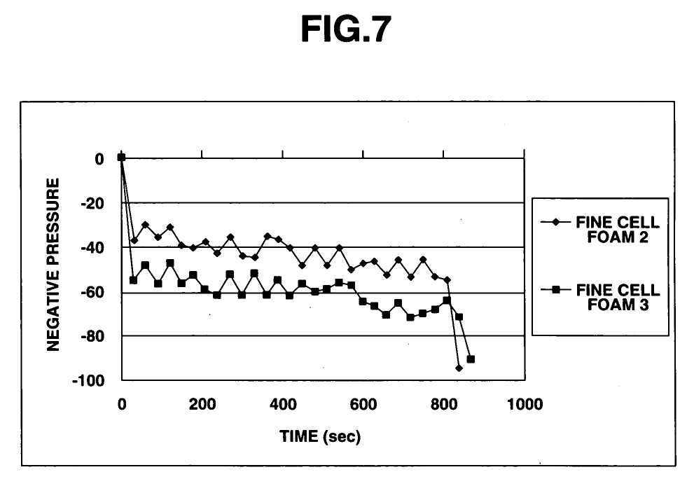

Incidentally, FIGS. 2 to 7 show negative-pressure characteristics in the cases where the ultra fine cell foams shown in Table 1 were pressed in various manners.

According to the present invention, the negative pressure was built up and was stable, with the use of a small amount of foam. Thus, an ideal negative-pressure characteristic is obtained. In addition, the amount of ink contained in the ink cartridge can be increased. Furthermore, by changing the material, it is possible to control the negative pressure.

1. An ink feeding member comprising an ink tank for storing an ink, and an ink discharge control material placed in said ink tank to close an ink discharge port of said ink tank and to partially fill said ink tank, characterized in that said ink discharge control material is comprised of an ultra fine cell foam or a hot press formed product thereof with a density of 0.06 g/cm³ or more, quantity of cells of 100/in or more, and a ventilation volume of 0.002 to 40 cc/cm²/sec.

2. An ink feeding member as set forth in claim 1, wherein said ink discharge control member has a density of 0.06 to 0.15 g/cm³, quantity of cells of 100 to 200/in, and a ventilation volume of 0.002 to 40 cc/cm²/sec.

3. An ink feeding member as set forth in claim 2, wherein said ink discharge control member has a density of 0.065 to 0.12 g/cm³, quantity of cells of 120 to 200/in, and a ventilation volume of 10 to 37 cc/cm²/sec.

4. An ink feeding member as set forth in claim 1, wherein said ultra fine cell foam is comprised of a soft polyurethane foam.

5. (currently amended): An ink feeding member as set forth in claim 1, wherein the filling factor of said ink discharge control material in filling said ink tank is 10 to 15% based on the internal volume of said ink tank.
